(19) United States
(12) Patent Application Publication
(10) Pub. No.: US 2007/0097495 A1
(43) Pub. Date: May 3, 2007

(54) APPARATUS FOR THE AUTOMATIC ADJUSTMENT OF THE VIEWER SETTINGS IN MICROSCOPES

(75) Inventors: Johannes Knoblich, Jena (DE); Thomas Serfling, Jena (DE); Tobias Kaufhold, Jena (DE); Detlef Hein, Goettingen (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(73) Assignee: Carl Zeiss Microlmaging GmbH

(21) Appl. No.: 11/538,994

(22) Filed: Oct. 5, 2006

(30) Foreign Application Priority Data
Oct. 5, 2005 (DE) 10 2005 047 594.9

(51) Int. Cl. G02B 21/00

(52) U.S. Cl. 359/384; 359/368

(57) ABSTRACT

The present invention is directed to an apparatus for the automatic adjustment of viewer settings in microscopes, particularly viewing height and viewing angle, interpupillary distance and/or dioptric compensation. In the apparatus according to the invention for the automatic adjustment of viewer settings in microscopes, the viewer settings with respect to viewing height and/or viewing angle and/or interpupillary distance and/or dioptric compensation can be automatically adjusted and/or predetermined, and these user-specific settings can be stored in a reproducible manner. The proposed solution is provided particularly for the automatic adjustment of viewer settings in microscopes regardless of the type of microscope. The solution according to the invention provides an apparatus for the automatic adjustment of viewer settings in microscopes by which the viewer settings can be adapted quickly and precisely to requirements, particularly to the requirements of different users. In this connection, the functionality of the microscope is improved, for example, by a constant regulation of a one-time preset ergonomic viewer setting, and the storage and reproduction of user-specific viewer settings are likewise improved.

### CROSS-REFERENCE TO RELATED APPLICATION

This application claims priority of German Application No. 10 2005 047 594.7, filed Oct. 5, 2005, the complete disclosure of which is hereby incorporated by reference.

### BACKGROUND OF THE INVENTION

a) Field of the Invention

The present invention is directed to an apparatus for the automatic adjustment of the viewer settings in microscopes, particularly the viewing height and viewing angle, interpupillary distance and/or dioptric compensation. The adjustment is carried out by means of electronic control.

b) Description of the Related Art

Ergonomic viewer settings are very important in traditional microscopy with viewing in two eyepieces because otherwise the user can experience tension and fatigue after a very short time. In order to adapt the viewer settings to different users and uses, several manufacturers offer so-called ergo-tubes which usually have a device for adjusting the viewing angle.

Usually, the interpupillary distance can be adjusted manually at the binocular tubes. Also, both eyepieces are usually outfitted with a lettered adjusting ring for manual compensation of individual visual deficiencies so that a different adjustment is possible for the left eye and right eye of the user.

Further, intermediate tubes which can be adjusted in height or also used in a fixed manner are known from the prior art for achieving a more favorable viewing height.

The known technical solutions for adjusting viewer settings have the disadvantage that the viewing height must be corrected manually by different parfocal lengths when specimens having different heights are used or after changing objectives. Further, it is necessary to manually readjust the viewing height and viewing angle, interpupillary distance and dioptric compensation when switching users. This is unnecessarily time-consuming and impedes the work flow particularly in an automated environment. As a result, optimal ergonomic adjustment is sometimes omitted, which can lead over time to neck tension, headaches, backaches, fatigue, loss of concentration and visual capacity, or similar physical discomforts in the user. But these ailments can also sometimes occur even after relatively brief use of a microscope which is not optimally adjusted.

The disadvantages of manual height adjustment which were described above have especially severe consequences in stereo microscopy, where specimens very often have different heights, and objectives with large differences in parfocal length are changed very frequently.

### OBJECT AND SUMMARY OF THE INVENTION

It is the primary object of the present invention to develop a solution by which the viewer settings can be adapted quickly and exactly to requirements, particularly for different users. In this connection, the functionality of the microscope is improved, for example, by means of a constant regulation of a one-time preset ergonomic viewer setting, and the storage and reproduction of user-specific viewer settings are likewise improved.

According to the invention, this object is met, in accordance with the invention, by an apparatus for the automatic adjustment of viewer settings in microscopes comprising means for automatically adjusting the viewer settings with respect to viewing height and/or viewing angle and/or interpupillary distance and/or dioptric compensation and means for storing the user-specific settings in a reproducible manner.

In the suggested solution for the automatic adjustment of viewer settings in microscopes, the viewer settings with respect to viewing height and/or viewing angle and/or interpupillary distance and/or dioptric compensation can be automatically adjusted and/or predetermined, and these user-specific settings can be stored in a reproducible manner.

The suggested solution is provided particularly for the automatic adjustment of the viewer settings in microscopes regardless of the type of microscope.

The invention will be described more fully in the following with reference to embodiment examples.

### BRIEF DESCRIPTION OF THE DRAWINGS

In the drawings:

FIG. 1 shows an intermediate tube whose height can be adjusted by motor; and

FIG. 2 shows the apparatus according to the invention incorporated in a total microscope system.

### DESCRIPTION OF THE PREFERRED EMBODIMENTS

In the apparatus, according to the invention, for automatic adjustment of the viewer settings in microscopes, the viewer settings with respect to viewing height and/or viewing angle and/or interpupillary distance and/or dioptric compensation can be automatically adjusted and/or predetermined and these user-specific settings can be stored so as to be reproduced.

In a first constructional variant, an intermediate tube which can be adjusted in height by motor is provided for adjusting the viewing height and is arranged in the infinity beam path. This intermediate tube whose height is adjustable by motor comprises two housing parts which are moved relative to one another by a stepper motor so that the effective length h_{T} of the intermediate tube is changed. The top and bottom coupling points of the intermediate tube whose height can be adjusted by motor are constructed as corresponding mating pieces.

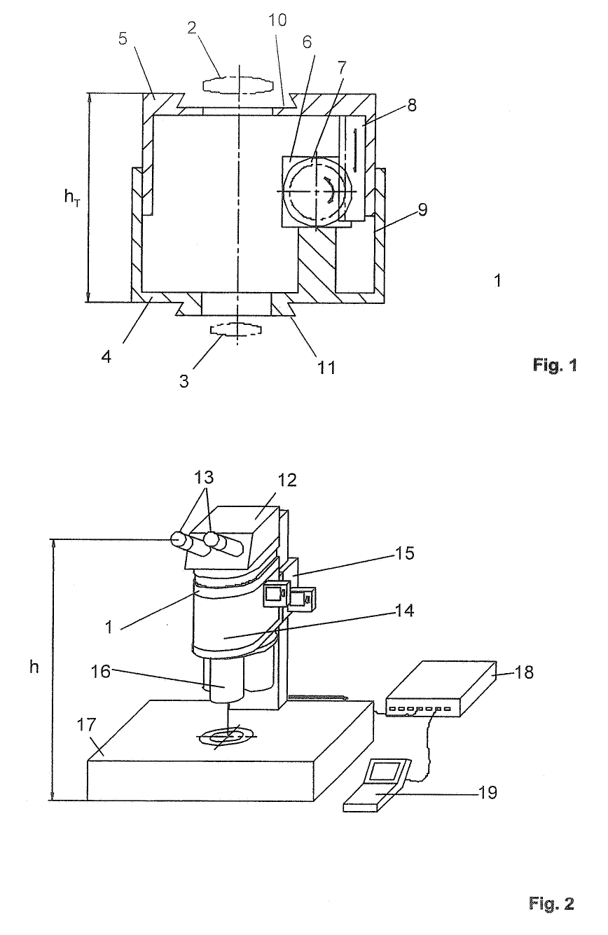

FIG. 1 shows an embodiment form of an intermediate tube which is adjustable in height by motor in the form of an intermediate tube that can be used in a modular manner. The following description and illustrations relate to only one beam path of a microscope.

The lenses shown in FIG. 1 outside the intermediate tube 1 are the tube lens 1 and the final lens 3 in the pancratic system of a microscope and do not belong to the unit according to the invention which is described herein. By arranging the intermediate tube 1 in the infinity beam path, the height h_{T} of the intermediate tube 1 which can be adjusted in height by motor can be varied sufficiently within certain limits without impermissibly worsening the imaging of the sample to be examined.

The intermediate tube 1 which can be adjusted in height by motor comprises two housing part 4 and 5. The adjustment of height h_{T} is carried out by means of a stepper motor 6. A pinion 7 which engages in a toothed rack 8 is attached to the motor shaft of the stepper motor 6. Since the stepper motor 6 is fastened to one housing part 4 and the toothed rack 8 is fastened to the other housing part 5, a relative movement takes place between the two housing parts 4 and 5 during rotation of the motor shaft and pinion 7 so that the effective length h_{T} of the intermediate tube can be changed. The housing parts 4 and 5 must be prevented from rotating during the relative movement. Corresponding guides 9, which are only suggested in FIG. 1, are provided for this purpose.

The position of the motor shaft and therefore the actual height h_{T} of the intermediate tube 1 can also be determined at any time through the stepper motor 6 so as to enable an exact positioning to a defined height h_{T}. For this purpose, the stepper motor must be initialized when switched on. After the stepper motor detects its initial position in this way, the current position, i.e., the height h_{T} of the intermediate tube 1, can be determined by evaluating the steps.

The intermediate tube 1 which can be adjusted in height by motor has coupling points 10 and 11 at the outer sides of the housing parts 4 and 5 for connecting to the tubes and pancratic system. Since the tubes should also be directly adaptable to the pancratic system, the coupling points 10 and 11 of the intermediate tube 1 which can be adjusted in height by motor are constructed as corresponding mating pieces.

In a second constructional variant, the two eyepiece receptacles of the existing eyepiece tube are mounted so as to be swivelable around a horizontal axis of rotation to adjust the viewing angle and are connected to a rotating mirror which is rotated around half of the swiveling angle of the eyepiece receptacles during the swiveling movement. The motor shaft of the actuating motor which is arranged at the housing of the eyepiece tube is connected to the swivelable eyepiece receptacles. The rotating mirror may only be rotated by one half of the swiveling angle of the eyepiece receptacles due to a fixed gear ratio so that an impermissible image offset cannot occur due to the swiveling movement.

In another constructional variant, the two eyepiece receptacles of the existing eyepiece tube are mounted so as to be rotatable, respectively, around a vertically extending axis which is identical to the optical axes of the two beam paths in order to adjust the interpupillary distance. The displacement of the optical axis into the mechanical axis of rotation is achieved by the arrangement of suitable deflecting mirrors or prisms. As a result of the rotation of the two eyepiece receptacles, their relative distance changes but, in spite of this, no image offset occurs. The rotating movements of the two eyepiece receptacles for varying the distance are realized by means of a motor whose motor shaft is connected to the swivelable eyepiece receptacles directly or via a gear unit. The housing of the stepper motor is fixedly connected to the housing of the eyepiece tube.

In another constructional variant, each of the adjusting rings which are provided at the two eyepieces and which are rotatable around their optical axes is driven by a respective stepper motor. The rotating movement of the adjusting ring is transformed along a motion thread into an axial movement of a lens assembly and/or the eyepiece receptacle. An individual focusing error of several diopters can be compensated in this way.

In another technical development, the eyepiece receptacle has an adjusting mechanism by which the entire eyepiece can be displaced for dioptric compensation. This has the advantage that eyepieces without a motor-driven adjusting ring can also be used.

The principles of motor-operated adjustment of the viewing angle, ocular distance and individual dioptric error are derived, for example, from the numerous existing solutions for manual adjustments through the additional use of stepper motors. Aside from their driving function, stepper motors also make it possible to detect the position of the driven functional assemblies and therefore make it possible to build control loops. Initialization of the stepper motor when switched on, as was mentioned above, is necessary for this purpose.

In a particularly advantageous construction, other adjustments carried out on the microscope which can cause a change in the viewer settings are checked and are used for readjusting the actual viewer settings if necessary.

FIG. 2 shows the incorporation of the apparatus according to the invention for the automatic adjustment of the viewer settings in an entire microscope system.

Aside from the intermediate tube 1 which can be adjusted in height by motor for adjusting viewing height, the total microscope system in the form of a stereo microscope contains the eyepiece tube 12, which can be adjusted by motor for adjusting the viewing angle and interpupillary distance, and the eyepieces 13 which can be adjusted by motor for adjusting the dioptric compensation, a motor-operated zoom unit 14, a motor-operated focusing drive 15, a coded objective changer 16 with three objectives, a transmitted-light illumination unit 17, a storage module 18, and a control panel 19. In another construction, the storage module 18 and control panel 19 can be integrated in the total microscope system.

Since all relevant components in the total microscope system are motor-actuated and/or coded, the general status of the system is always known and stored in the storage module 18. The desired adjustments are implemented by means of the control panel 19.

The viewing height h is known in that all components are linked electronically to a total system. The corresponding expected focus position is adjusted by the motor-actuated focusing drive 15 based on the objective of the coded objective changer 16 and its working distance and structural length. When using objectives with a short working distance, there may be contact between the sample and the objective in case of very high samples so that a manual focusing in the expected focus position is preferable in such cases.

The expected focus positions and the manually adjusted or readjusted focus positions are conveyed to the intermediate tube, according to the invention, whose height is adjustable by motor and which can provide for a uniformly constant viewing height h by means of a control loop. By presetting a desired viewing height, the intermediate tube 1 can quickly and automatically adapt the actual viewing height h to an ergonomic viewer setting.

In another particularly advantageous construction, the adjustment of the viewer settings with respect to viewing height and/or viewing angle and/or interpupillary distance and/or dioptric compensation can be carried out in such a way that the settings are changed by the operator via the control panel 19 until the viewer settings are optimal for that operator. These settings can then be stored in the storage module 18 for the specific user. However, it is also possible for the operator to use the control panel 19 to retrieve the settings that have already been stored for that operator and to adjust these settings automatically.

The data for a plurality of users can be managed by the total system so that when changing users the viewer settings can be adapted to a new user by the total system by pressing a button.

In another construction, upward movements of the focusing unit with the tube and the eyepieces which are carried out quickly by motor can be buffered by the apparatus according to the invention in that the intermediate tube which can be adjusted in height by motor counteracts these movements. This prevents a fast movement of the eyepieces in direction of the eyes which is unpleasant for the user.

The solution according to the invention provides an apparatus for the automatic adjustment of viewer settings in microscopes by which the viewer settings can be adapted quickly and precisely to requirements, particularly to the requirements of different users. In this connection, the functionality of the microscope is improved, for example, by means of a constant regulation of a one-time preset ergonomic viewer setting, and the storage and reproduction of user-specific viewer settings are likewise improved.

While the foregoing description and drawings represent the present invention, it will be obvious to those skilled in the art that various changes may be made therein without departing from the true spirit and scope of the present invention.

What is claimed is:

1. An apparatus for the automatic adjustment of viewer settings in microscopes comprising:
means for automatically adjusting and/or predetermining the viewer settings with respect to viewing height and/or viewing angle and/or interpupillary distance and/or dioptric compensation; and
means for storing said user-specific settings in a reproducible manner.

2. The apparatus according to claim 1, in which an intermediate tube which can be adjusted in height by motor is provided for the adjustment of the viewing height and is arranged in the infinity beam path.

3. The apparatus according to claim 1, in which the intermediate tube whose height is adjustable by motor comprises two housing parts which are moved relative to one another by a stepper motor so that the effective length h_{T} of the intermediate tube is changed.

4. The apparatus according to claim 1, in which the top and bottom coupling points of the intermediate tube whose height can be adjusted by motor are constructed as corresponding mating pieces.

5. The apparatus according to claim 1, in which the two eyepiece receptacles of the existing eyepiece tube are mounted so as to be swivelable around a horizontal axis of rotation to adjust the viewing angle and are connected to a rotating mirror which is rotated around half of the swiveling angle of the eyepiece receptacles during the swiveling movement, wherein the motor shaft of the actuating motor which is arranged at the housing of the eyepiece tube is connected to the swivelable eyepiece receptacles directly or via a gear unit.

6. The apparatus according to claim 1, in which the two eyepiece receptacles of the existing eyepiece tube are mounted so as to be rotatable, respectively, around a vertically extending axis which is identical to the optical axes of the two beam paths in order to adjust the interpupillary distance, wherein the motor shaft of the actuating motor which is arranged at the housing of the eyepiece tube is connected to the swivelable eyepiece receptacles directly or via a gear unit.

7. The apparatus according to claim 1, in which the adjusting rings which are provided at the two eyepieces and which are rotatable around their optical axes are driven by a respective stepper motor for adjustment of the dioptric compensation.

8. The apparatus according to claim 1, in which each of the two eyepiece receptacles of the existing eyepiece tube has an adjusting mechanism by which the entire eyepiece can be displaced for dioptric compensation.

9. The apparatus according to claim 1, in which the settings which can cause a change in the viewing conditions are checked and are used for readjusting the actual viewer settings if necessary.
